(19) United States
(12) Patent Application Publication
(10) Pub. No.: US 2004/0174411 A1
(43) Pub. Date: Sep. 9, 2004

(54) Inkjet head and method for manufacturing the same

(75) Inventors: Toshiharu Sumiya, Ibaraki (JP); Satoru Tobita, Ibaraki (JP); Yoshitaka Akiyama, Ibaraki (JP); Kenichi Kugai, Ibaraki (JP)

Correspondence Address: MCGINN & GIBB, PLLC, 8321 OLD COURTHOUSE ROAD, SUITE 200, VIENNA, VA, 22182-3817, US

(73) Assignee: Hitachi Printing Solutions, Ltd., Tokyo (JP)

(21) Appl. No.: 10/793,030

(22) Filed: Mar. 5, 2004

(30) Foreign Application Priority Data
Mar. 7, 2003 (JP) P.2003-060727

(51) Int. Cl. B41J 2/14; B41J 2/16

(52) U.S. Cl. 347/47; 347/45

(57) ABSTRACT

An inkjet head includes a nozzle orifice, a pressure chamber, and a pressure generator that displaces an internal volume of the pressure chamber to eject an ink droplet from the nozzle orifice. Preferably, the nozzle orifice includes a nozzle exit for ejecting ink, a first projecting section disposed around the nozzle exit, a step section disposed outside the first projecting section and a position lower than the same, and a second projecting section disposed outside the step section and at a position higher than the first projecting section, and the second projecting section is subjected to ink-repellent treatment.

### BACKGROUND OF THE INVENTION

1. Field of the Invention

The present invention relates to an inkjet head nozzle which forms an ink image on a recording medium by means of applying pressure to ink, to thereby eject ink droplets from nozzles.

2. Background Art

There has already been known an inkjet head which subjects the volume of a pressure chamber to displacement by means of pressure generation means, such as a piezoelectric element, to thereby eject ink from nozzles as described in, e.g., JP-A-1-115638.

In the case of, e.g., an inkjet head using piezoelectric elements, a ceramic member is provided on an end face of the piezoelectric element, and a vibrative surface of the piezoelectric element is disposed opposite an entrance opening section of the nozzle and fixedly bonded to a housing. In order to cause the inkjet head to eject ink droplets, a voltage is applied from an external drive source to an individual electrode and a common electrode, to thereby deform the piezoelectric element. This deformation appears as a volumetric change in the pressure chamber via a diaphragm, thereby causing a change in the pressure of the ink filling the pressure chamber. The nozzle ejects ink as an ink droplet by means of the pressure change.

In the inkjet head, in order to achieve highprint quality, an ink droplet to be ejected from a nozzle must always travel in a straight line at right angles to a nozzle substrate (i.e., an orifice plate). However, when areas around the nozzle have become wet unevenly with the ink that has overflowed at the time of ejection of an ink droplet or when an extraneous material or a flaw is present in the areas around the nozzle, an ink droplet fails to fly straight. In order to prevent such an occurrence, the areas around the nozzle must be evenly wet with ink and protected from extraneous matter or a flaw.

As shown in FIG. 3, in order to render constant the quantity of ink accumulated around the nozzle, a related-art nozzle assumes a projecting shape (see, e.g., JP-A-2-155651). As shown in FIG. 3, the area around the perimeter of anozzle orifice 24 has a projecting shape with respect to the nozzle substrate 2. Ink 26 which has overflowed to the perimeter of the nozzle at the time of ejection of ink flows to a non-projecting surface of a non-projecting section, thereby achieving stable print quality.

In some inkjet heads, a cover plate 21 is provided on an upper surface of the nozzle plate 20, and a recessed step section is provided in the vicinity of the nozzle orifice (e.g., JP-UM-A-59-153128). The cover plate 21 provided on the nozzle surface has an aperture whose diameter is several times the diameter of the nozzle orifice and which is provided concentrically with the nozzle. The aperture is provided around the nozzle as a step section. Ink forms a thin ink layer 23 within the step section, and an ink droplet 27 is ejected so as to break through the ink layer 23.

As shown in FIGS. 6A and 6B, a recessed opening is formed, and an ink ejection port having a projecting shape is formed at the center of the bottom of the opening (see, e.g., JP-A-5-509). An ink-repellent substance 125 is applied around the outside of an ink ejection port 124. An ink meniscus is formed from the ink ejection port 124. A first electrode 151 is disposed around the recessed section, and a second electrode 152 is disposed in the vicinity of the ink ejection port. When a signal voltage is applied to the first and second electrodes 151, 152, ink is withdrawn by means of electrostatic force, whereupon ink flies to the outside along a center line of the recessed opening section.

As shown in FIG. 5, in some inkjet nozzles, the recessed step section is subjected to water repellent treatment (see, e.g., Japanese Patent No. 3,108,771). An ink layer is not formed in the step section, and the ink droplet 27 is ejected from the nozzle.

### SUMMARY OF THE INVENTION

However, the shape of the previously-described related-art projecting nozzle causes the ink that has overflowed to the outer periphery of the nozzle to extend from the outer periphery of the nozzle, whereupon the ink will not return into the nozzle. The nozzle substrate does not have any ink-repellent characteristic, and hence the overflowed ink spreads over the nozzle substrate. In contrast, when a recessed step section is provided, the ink of the ink layer remaining within the step section can return into the nozzle after having been ejected. However, the ink remaining on a flat section having no ink-repellent characteristic does not return into the nozzle. If residual ink, such as unwiped ink or splashed ink, adheres to the flat section (hereinafter called “residual ink”), ink leaks and spreads over the nozzle substrate from a puddle of ink in the step section while the residual ink is taken as a start point.

As mentioned above, according to the related-art technique, when the inkjet head is continuously operated over a long period of time, the ink puddle spreads over the nozzle substrate and is then linked to an ink puddle of an adjacent nozzle. When a link is established between the ink puddles, the adjacent nozzles affect each other, thereby rendering nonuniform the wetness of ink remaining around the nozzles. Consequently, an ink droplet fails to fly straight.

According to the related-art technique for subjecting the inside of the step section to water-repellent treatment, the areas around the nozzles are protected from wetting by means of water-repellent treatment. However, if cleaning is insufficient or the inkjet head is operated continuously over a long period of time, splashed ink adheres to the areas around the nozzles, and the residual ink is accumulated around the nozzles. When the nozzles are splashed with the thus-residual ink, an ink droplet is attracted by the residual ink, thereby causing a failure of the ink droplet to fly straight. Accordingly, when the inkjet head is operated continuously over a long period of time, there arises a problem of an ink droplet failing to fly straight.

The present invention solves such a problem in the conventional technique and is aimed at providing an inkjet head which causes ink droplets to stably travel in a straight line over a long period of time, to thereby provide high print quality.

According to an aspect of the invention, an inkjet head includes a nozzle orifice, a pressure chamber, and a pressure generator that displaces an internal volume of the pressure chamber to eject an ink droplet from the nozzle orifice. Preferably, wherein the nozzle orifice includes a nozzle exit for ejecting ink, a first projecting section disposed around the nozzle exit, a step section disposed outside the first projecting section and a position lower than the same, and a second projecting section disposed outside the step section and at a position higher than the first projecting section, and the second projecting section is subjected to ink-repellent treatment.

According to another aspect of the invention, an ink-jet head includes a nozzle orifice, a pressure chamber, and a pressure generator for displacing an internal volume of the pressure chamber to eject an ink droplet from the nozzle orifice. Preferably, the nozzle orifice includes a nozzle exit for ejecting ink and a projecting section being spaced a predetermined distance away from the nozzle exit, and the projecting section is subjected to ink-repellent treatment.

The invention also provides a method for manufacturing an inkjet head for ejecting an ink droplet from anozzle orifice section by displacing an internal volume of a pressure chamber by means of pressure generator including providing a nozzle plate with a plurality of nozzle exits for ejecting ink, cementing a cover plate to a surface of the nozzle plate from which ink is to be ejected, and subjecting the surface of the cover plate to ink-repellent film treatment to form the nozzle orifice.

### BRIEF DESCRIPTION OF THE DRAWINGS

The present invention may be more readily described with reference to the accompanying drawings:

FIG. 1A is a plan view showing a periphery of a nozzle of an inkjet head according to the invention;

FIG. 1B is a cross-sectional view of the same;

FIG. 2 is a structural, descriptive, and perspective view of a principal section of the inkjet head;

FIG. 3 is a conceptual rendering showing an accumulated state of ink around a nozzle of a related-art inkjet head;

FIG. 4 is a conceptual rendering showing an ejected state of ink of the related-art inkjet head;

FIG. 5 is a conceptual rendering showing an ejected state of ink of the related-art inkjet head;

FIG. 6A is a plan view showing a periphery of a nozzle of the related-art inkjet head;

FIG. 6B is a cross-sectional view of the same;

FIGS. 7A to 7D are process drawings showing a method for manufacturing a nozzle substrate of the invention;

FIG. 8 is a conceptual rendering showing an ejected state of ink of the inkjet head;

FIG. 9 is a conceptual rendering showing an ejected state of ink of the inkjet head according to the invention;

FIG. 10 is a cross-sectional view of a periphery of the nozzle, showing another example of an area to be subjected to ink-repellent treatment;

FIGS. 11A and 11B are conceptual renderings showing migration of residual ink of the inkjet head according to the invention;

FIG. 12A is a plan view showing a periphery of a nozzle of an inkjet head according to a second embodiment of the invention;

FIG. 12B is a cross-sectional view of the same;

FIG. 13 is a conceptual rendering showing an ejected state of ink according to the second embodiment;

FIGS. 14A and 14B are cross-sectional views showing the configuration of the periphery of the nozzle when a nozzle substrate is constituted of a single member; and

FIGS. 15A and 15B are cross-sectional views showing the configuration of the periphery of the nozzle according to the embodiment in which the sidewall surface of a step section is tapered.

### DETAILED DESCRIPTION OF THE PREFERRED EMBODIMENTS

An embodiment of the invention will be described hereinbelow by reference to the drawings.

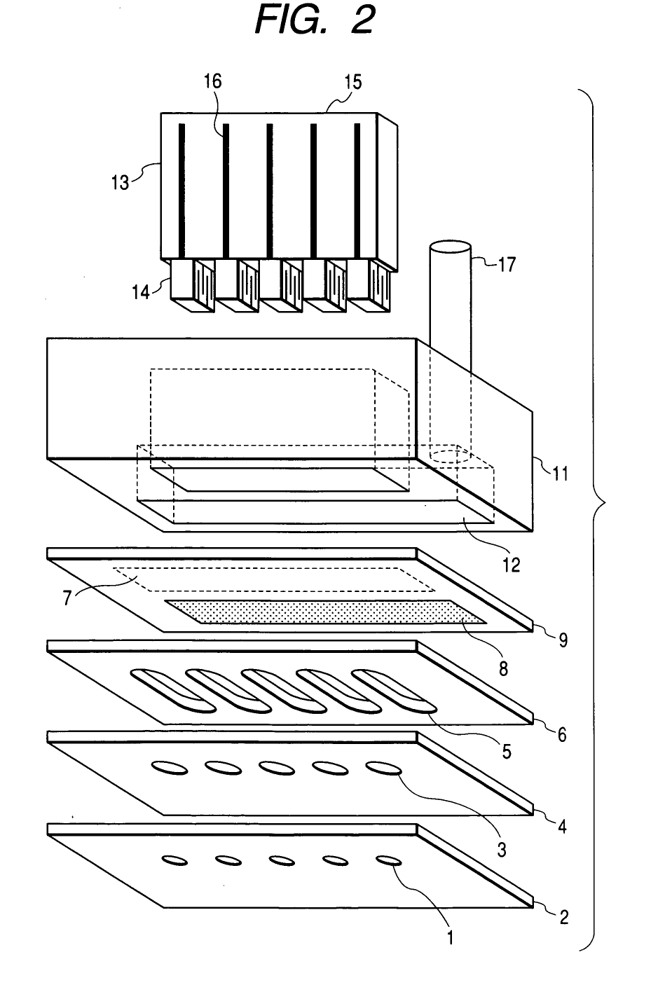

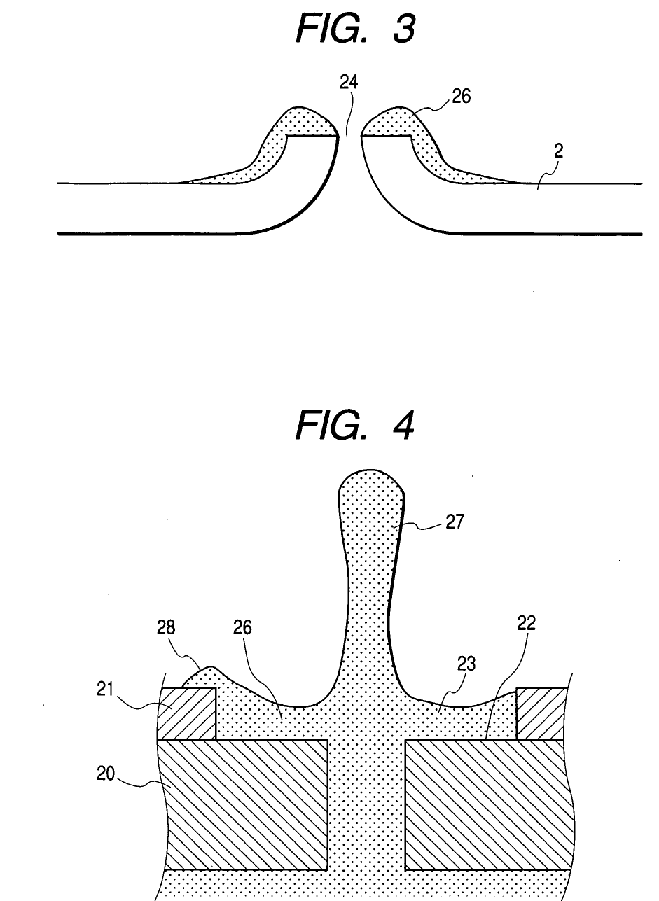

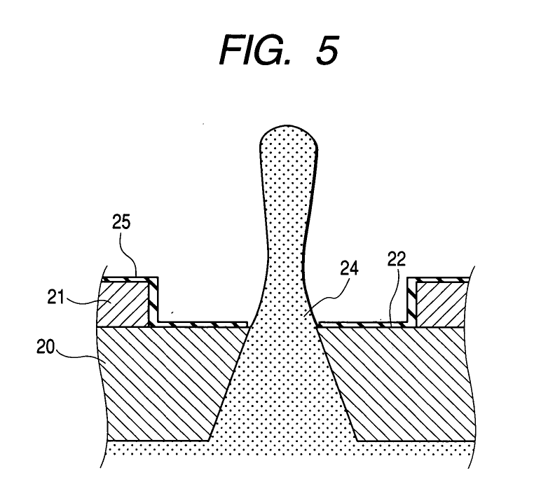

FIG. 2 is an exploded perspective view for describing the structure of the principal section of an inkjet head of the invention. Reference numeral 2 designates a nozzle substrate having a plurality of nozzles 1 formed therein. The machining accuracy of the shape of the opening of the nozzles 1 greatly affects the ink ejection characteristic of the ink-jet head. In order to suppress a variation in the accuracy of a nozzle between the plurality of nozzles 1, the method for producing the nozzle substrate 2 requires high machining accuracy. For this reason, the nozzle substrate 2 is formed by means of precision pressing of stainless steel, a laser beam machining method, electrocasting of nickel, or the like.

A chamber plate 4 having pressure chambers 3 formed therein, and a restrictor plate 6 are positioned and cemented to the nozzle substrate 2, wherein restrictors 5 for coupling a common ink channel 12 to the pressure chambers 3 to control inflow of ink into the pressure chambers 3 are formed in the restrictor plate 6. Moreover, a diaphragm plate 9 and a housing 11 are positioned and cemented to the nozzle substrate 2 in the same manner. Formed in the diaphragm plate 9 are a diaphragm 7 for efficiently transmitting the pressure of a piezoelectric actuator 13 to the pressure chambers 3 and a filter section 8 for removing wastes or the like from the ink flowing from the common ink channel 12 to the restrictors 5. Further, the common ink channel 12 is formed in the housing 11. The chamber plate 4, the restrictor plate 6, and the diaphragm plate 9 are formed by means of etching a stainless steel material or electrocasting a nickel material. The housing 11 is formed by means of cutting a stainless steel material. An ink inlet pipe 17 for introducing ink from an unillustrated ink cartridge to the common ink channel 12 is cemented to the housing 11.

Finally, a plurality of piezoelectric elements 14 and the piezoelectric actuator 13 constituted of a support substrate 15 for fastening the piezoelectric elements 14 are positioned and cemented to the housing 11. The piezoelectric actuator 13 is constituted of a plurality of the piezoelectric elements 14, and the respective piezoelectric elements 14 are associated with the pressure chambers 3 in a one-to-one correspondence. Moreover, individual electrodes 16, which are to be used for transmitting independent electric signals from an unillustrated external drive circuit to the piezoelectric elements 14, are formed on the support substrate 15. As a result of application of selective electric signals from the external drive circuit to the piezoelectric elements 14, strain arises in the piezoelectric elements 14. Since the piezoelectric elements 14 are cemented onto the highly-rigid support substrate 15, displacement is imparted in preference to the diaphragm 7, thereby increasing the pressure of the pressure chamber 3. The inkjet head to be described in the present embodiment ejects ink from the nozzles 1 on the basis of such a principle.

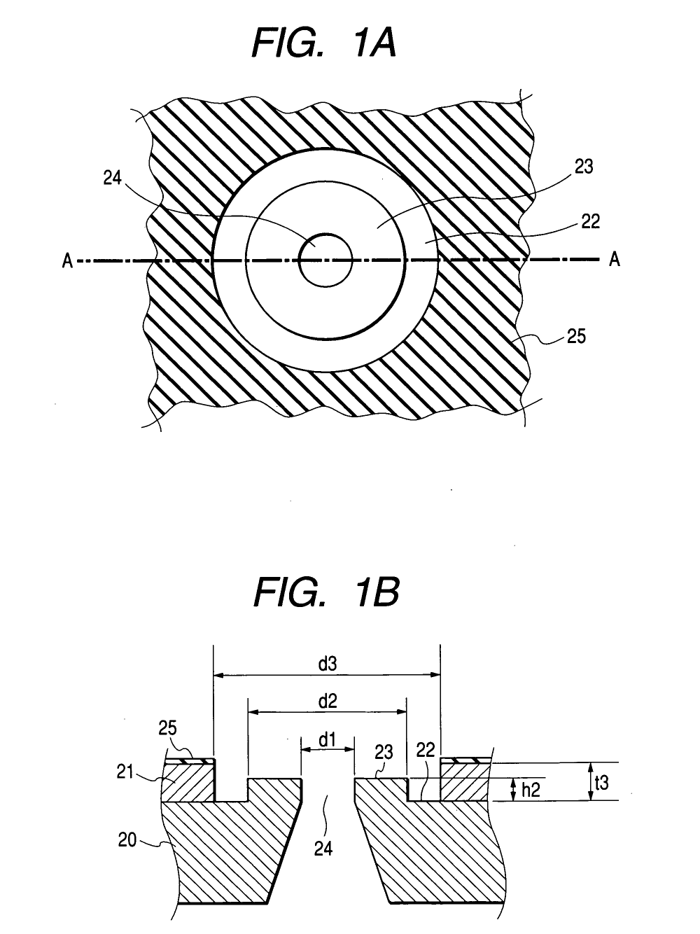

FIGS. 1A and 1B show a step section 22, a projecting section 23, and a nozzle exit 24, all being located in the vicinity of the nozzle 1 of an inkjet head of a first embodiment of the invention. FIG. 1A is a plan view; and FIG. 1B is a cross-sectional view taken along line A-A shown in FIG. 1A.

The nozzle substrate 2 is constituted of two members; that is, a nozzle plate 20 and a cover plate 21. The nozzle plate 20 and the cover plate 21 are formed by means of precision pressing of stainless steel; laser beam machining; etching; or electrocasting of nickel. The step section 22 is formed by cementing the cover plate 21 to the nozzle plate 20.

A front end face of each nozzle exit 24 of the nozzle plate 20 is formed flush with the projecting section 23. The projecting section 23 can be formed by means of, e.g., precision pressing. The projecting section 23 is substantially concentric with the step section 22 and the nozzle exit 24. A diameter d2 of the projecting section 23 is two to four times a bore diameter d1 of the nozzle exit 24.

The step section 22 is formed for each nozzle 1 and is substantially concentric with the nozzle exit 24. A diameter d3 of the step section 22 is four to eight times the bore diameter d1 of the nozzle exit 24. The surface of the cover plate 21 is subjected to ink-repellent treatment, thereby forming an ink-repellent film 25.

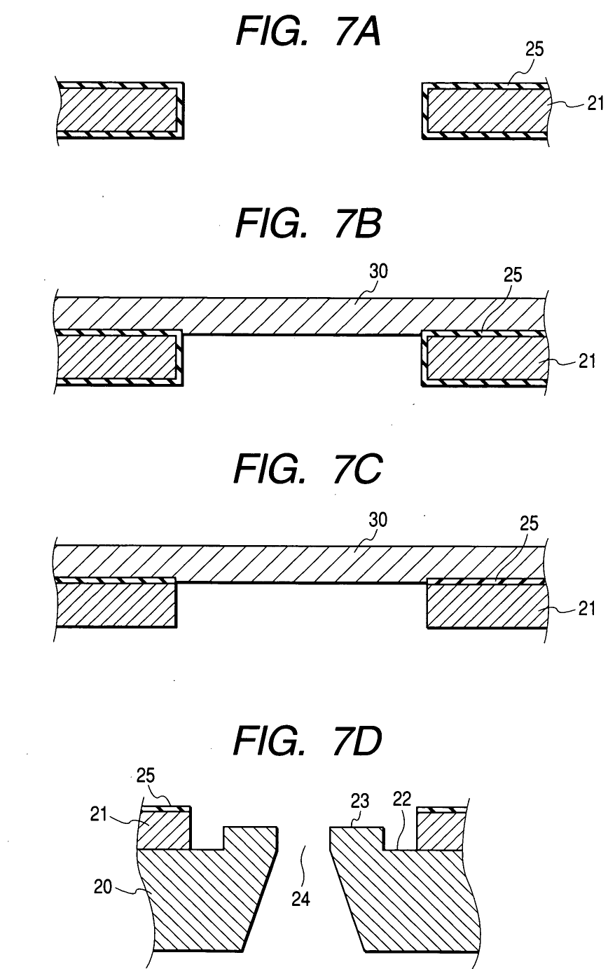

FIGS. 7A to 7D illustrate a process pertaining to a method for forming the nozzle substrate 2 in which the ink-repellent film 25 is formed on the surface of the cover plate 21. First, the ink-repellent film 25 is formed over the entire cover plate 21 (FIG. 7A). Next, the surface by way of which an ink droplet is to be ejected or a sidewall surface of the opening section of the cover plate 21 is coated with a mask material 30 (FIG. 7B), and the ink-repellent film 25 is exfoliated from the surface to which the nozzle plate 20 is to be bonded (FIG. 7C). After exfoliation of the mask material 30, the center of the nozzle orifice section of the nozzle plate 20 is positioned and cemented to the cover plate 21 (FIG. 7D). For instance, through use of a laminating machine or the like, a dry resist film manufactured by DuPont-Toray Co., Ltd. is brought, as a material to be used for the mask material 30 and also as a protective film, into tight contact with the ink-repellent film 25. The protective film can be formed on the sidewall of the aperture by means of controlling the pressure and heat used in laminating the resist film. The protective film can be readily exfoliated when immersed in sodium hydroxide. The ink-repellent film 25 can be readily exfoliated by means of a plasma etching method.

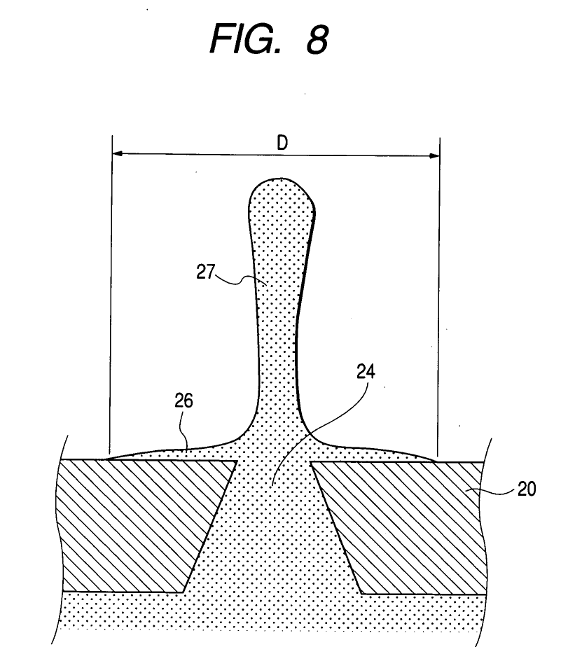

FIG. 8 is a descriptive view showing a state in which an ink droplet 27 is ejected from the nozzle substrate 2 where neither the step section 22 nor the projecting section 23, both pertaining to the present embodiment, are present. The diameter d2 of the projecting section 23 and the diameter d3 of the step section 22 are determined by observation of the diameter D of an ink puddle 26 which has overflowed to the periphery of the nozzle exit 24 when ejection of ink is initiation. A test conducted by the present inventor shows that the diameter of the ink puddle 26 formed at the initiation of ejection operation assumes 200 to 400 μm or thereabouts, in contrast with the bore diameter d1 of the nozzle exit 24, which assumes a value of 50 μm. The diameter D of the ink puddle 26 is about four to eight times the bore diameter d1 of the nozzle exit 24. Therefore, the diameter d2 of the projecting section 23 is smaller than the diameter D of the ink puddle. Preferably, the diameter d3 of the step section 22 is made essentially equal to the diameter D of the ink puddle 26. As a result, since the diameter d2 of the projecting section 23 is smaller than the diameter D of the ink puddle, the periphery of the nozzle exit 24 becomes uniformly wet with ink at all times, whereby excessive ink flows to the step section 22. Consequently, failure of an ink droplet to fly straight, which would otherwise be attributable to uneven wetness of ink, is prevented, and the ink droplet travels in a straight line stably.

In relation to the configuration of the present embodiment, if the diameter d3 of the step section 22 is excessively smaller than the diameter D of the ink puddle, the volume of ink to be dammed up with the step section 22 becomes deficient, and the ink having overflowed from the step section 22 spreads to the cover plate, thereby causing a failure of an ink droplet to fly straight. If the diameter d3 is excessively larger than the diameter D, the ink puddle 26 fails to spread uniformly, and consequently the ink puddle 26 spreads in a nonuniform manner in the step section 22. A result of an additional test shows that the diameter d3 of the step section 22 is preferably set so as to become essentially identical with the diameter D of the ink puddle formed at the initiation of ejection operation. A portion of the ink puddle 26 stored in the step section 22 is sufficiently close to the nozzle exit 24. Hence, that portion is withdrawn to the inside of the nozzle during intervals between operations for ejecting the ink droplet 27. Consequently, the ink puddle 26 becomes saturated at a constant volume. Therefore, an ink droplet can be continually ejected in a steady state. From a test using a nozzle substrate formed while the diameter d3 of the step section 22 is made six times as large as the nozzle diameter d1, it can be ascertained that the ink puddle 26 does not overflow from the step section 22 even during the course of ejection operation which continues for 30 minutes and that the ink puddle 26 has a sufficient volume.

The thickness t3 of the cover plate 21 is set so as to become greater than the height h2 of the projecting section 23 of the nozzle plate 20. Therefore, the front surface of the nozzle exit 24 is located at a position lower than the surface of the cover plate 21. As a result of the projecting section 23 being made lower than the flat section of the nozzle substrate 2, a wiper, such as a wiper made of rubber, will not be caught by the projecting section 23 when the nozzle substrate 2 is wiped by the wiper through an operation for cleaning the ink-jet head, thereby preventing infliction of flaws on the nozzle exit 24, which would otherwise be caused by the wiper or by extraneous matter adhering to the wiper. There is also yielded an effect of rendering the nozzle exit 24 resistant to flaws when a recording medium has come into contact with the nozzle substrate 2 for reasons of rubbing of paper or a paper jam.

In a test in which the bore diameter d1 of the nozzle exit 24 was set to 50 μm and the thickness t3 was set to 5 μm, ink could not be dammed. The ink puddle 26 flowed to the flat section within 60 seconds. In contrast, in a test in which the thickness t3 was set to 20 μm, the ink puddle 26 did not flow from the step section 22. The result of this test shows that the thickness t3 sufficient to dam the ink overflowed from the nozzle exit 24 is at least two-fifths or more the bore diameter d1 of the nozzle exit 24. When the thickness t3 is made equal to or greater than the bore diameter d1 of the nozzle exit 24, a difference in the effects for damming ink is eliminated. However, this leads to an inconvenience of a failure to sufficiently clean the nozzle exit 24 during a cleaning operation. Therefore, the bore diameter d1 of the nozzle exit 24 and the thickness t3 of the cover plate must satisfy a relationship of (2/5)d1<t3<d1.

FIG. 9 is a descriptive view of an ink ejection operation performed by the configuration of the nozzle substrate of the present embodiment. Excessive ink flows into the step section 22 by virtue of the projecting section 23. The periphery of the nozzle exit 24 is uniformly wet, and the ink droplet 27 stably travels in a straight line. Excessive ink flows to the step section 22, and the ink puddle 26 remaining at the front surface of the projecting section 23 is the only ink that would affect ink at the time of ejection. Therefore, the tail of the ink droplet becomes narrow, and the ink droplet 27 is immediately torn off the ink puddle 26, thereby yielding an effect of shortening a ligament.

As a result of the step section 22 being provided by means of the cover plate 21, the ink puddle 26 can be dammed by means of the step section 22. For instance, the step section 22 formed from a stainless base material has a contact angle of 55° or less with respect to pure water. Hence, the ink puddle 26 extends over the entire step section 22. Meanwhile, an ink-repellent film 25 is provided on the surface of the cover substrate 2, and the contact angle is set to 100° or more, whereby the step section 22 can dam the ink puddle 26 within the step section 22 without fail. Therefore, the ink puddle 26 having overflowed from the nozzle exit 24 does not affect other, adjacent nozzles.

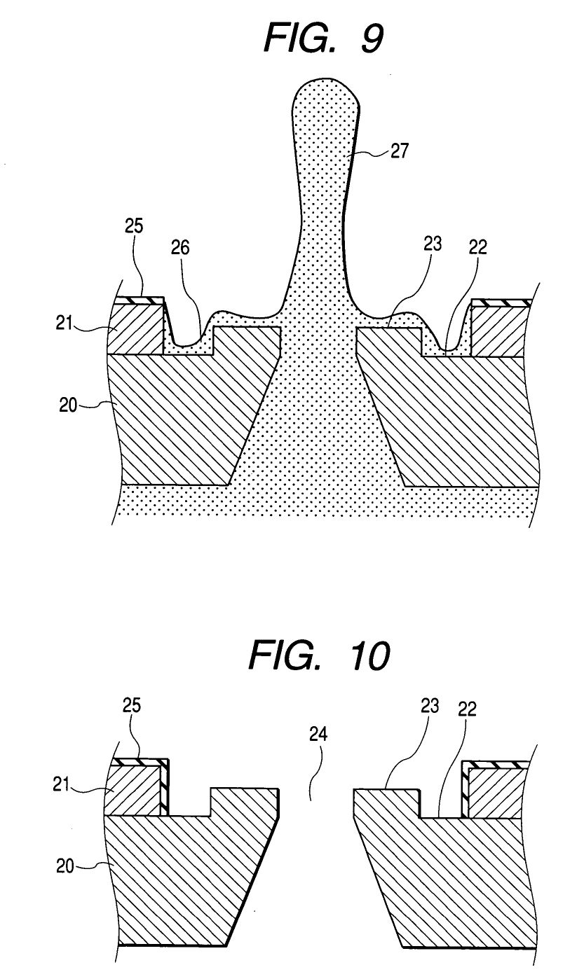

FIG. 10 shows a modification of the present invention. As shown in FIG. 1, the surface of the cover plate 21 may be subjected to ink-repellent treatment. However, as shown in the illustrated embodiment, the ink-repellent film 25 may be provided up to the side wall surface of the cover plate 21. By means of such a configuration, ink can be dammed more reliably.

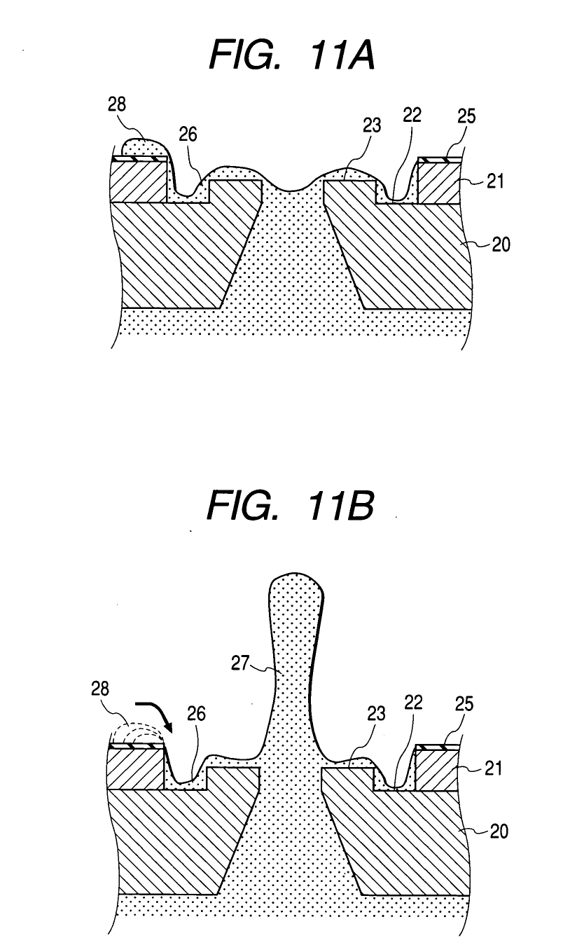

FIGS. 11A and 11B are conceptual renderings showing migration of ink when the cover plate 21 is stained with the residual ink 28 in connection with the configuration of the nozzle substrate of the invention. FIG. 11A shows a state in which the ink left after cleaning or splashed ink resulting from flying of ink from the nozzle adheres, as the residual ink 28, to the boundary between the cover plate 21 and the step section 22. FIG. 11B shows migration of the residual ink 28 at the time of ejection of ink. As shown in FIG. 11A, even when the residual ink 28 has come into contact with the ink puddle 26 of the step section 22, the residual ink 28 is absorbed by the step section 22 in the manner as shown in FIG. 11B, by means of vibration of a meniscus caused at the time of ejection of ink and the effect of the ink-repellent film 25. The surface of the nozzle substrate 2 becomes resistant to stains by means of combination of the ink-repellent film 25 and the ink puddle 26 of the step section 22, both pertaining to the invention. Hence, an interval between cleaning operations can be made longer. Since a certain amount of residual ink can be allowed, the cleaning device can be formed from a simple configuration.

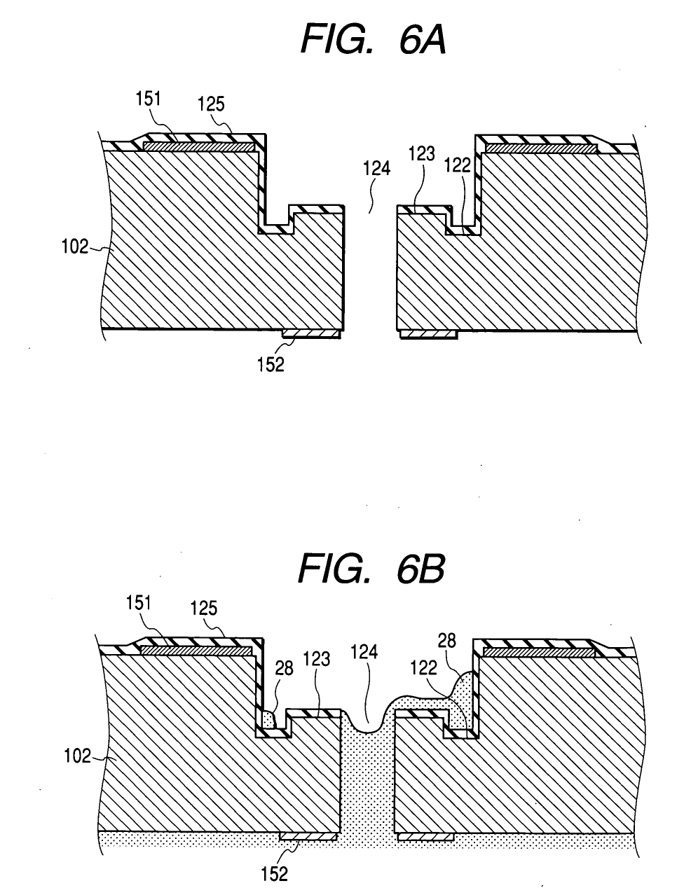

In the related-art embodiment described in JP-A-5-509, which is shown in FIG. 6A, the sidewall and periphery of a step section 122 and an outer periphery of an ink exit 124 are subjected to ink-repellent treatment, thereby forming an ink-repellent film 125. The ink meniscus is retained by an outer edge of the nozzle exit 124, and no ink puddle is formed around the nozzle exit 124. However, a wiper fails to sufficiently come into contact with an angled portion of the step section 122 and that of the sidewall during cleaning of the nozzle, for reasons of a recessed structure of the periphery of the nozzle. Residual ink produced at the time of wiping operation is likely to remain as the residual ink 28.

FIG. 6B shows an example of the residual ink 28. The residual ink left after wiping operation and the splashed residual ink 28 have nowhere to go and remain on the surface of the nozzle substrate 102, because the surface of the nozzle substrate 102 has an ink-repellent characteristic. When the residual ink 28 has built up and rested on a portion of the nozzle exit 124, the periphery of the ink exit 124 becomes wet unevenly. The ink droplet 27 is withdrawn to the ink puddle, whereupon the ink droplet fails to fly straight.

In the case of the present invention in which the step section 22 is not subjected to water-repellent treatment, the periphery of the nozzle exit 24 and the step section 22 remain easily wettable. Hence, the invention has the advantage of the bottom and side surfaces of the step section 22 becoming evenly wet even when there still remains the residual ink 28 stemming from incomplete wiping operation or splashes. As a result of the step section 22 becoming evenly wet, the periphery of the nozzle exit 24 is prevented from becoming unevenly wet with the residual ink 28, thereby retaining a superior rectilinear propagation characteristic of ink. The surface of the cover plate 21 other than the step section 22 has an ink-repellent characteristic imparted by the ink-repellent film 25. Hence, the amount of residual ink which would be caused during a cleaning operation becomes small. Even when splashed ink has adhered to the cover plate 21, the residual ink 28 does not extend to the step section 22, by virtue of the ink-repellent characteristic, thereby yielding an effect of resistance to the influence of splashing.

In order to make the step section 22 wet more actively, the bottom surface of the step section 22 maybe imparted affinity for ink through treatment (hereinafter called “ink affinity treatment”). The step section 22 may be subjected to ink affinity treatment by bonding the nozzle plate 20 to the cover plate 21 after the nozzle plate 20 has been subjected to ink affinity treatment. A more stable effect can be yielded by subjecting the step section 22 to ink affinity treatment.

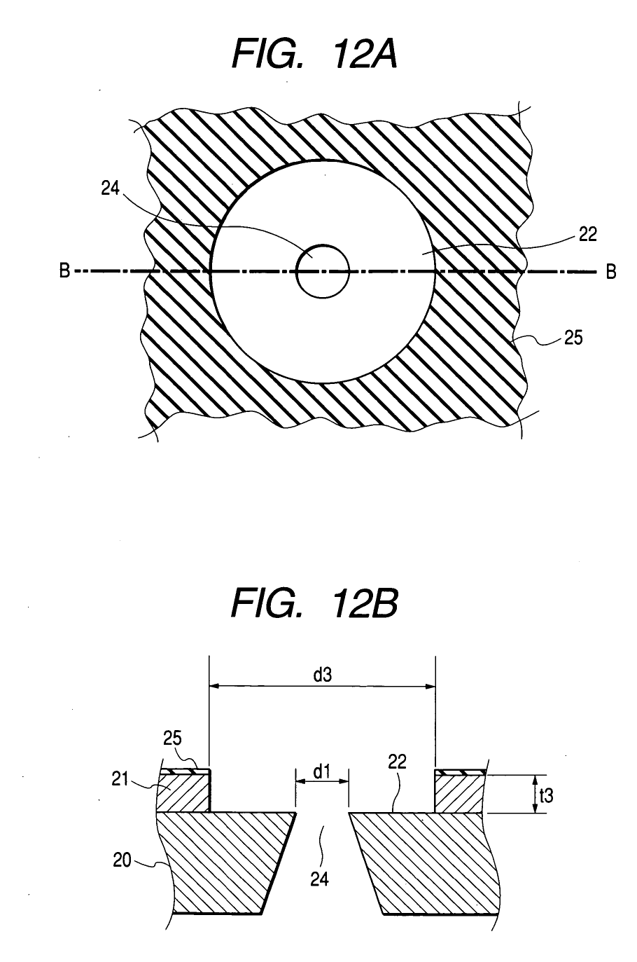

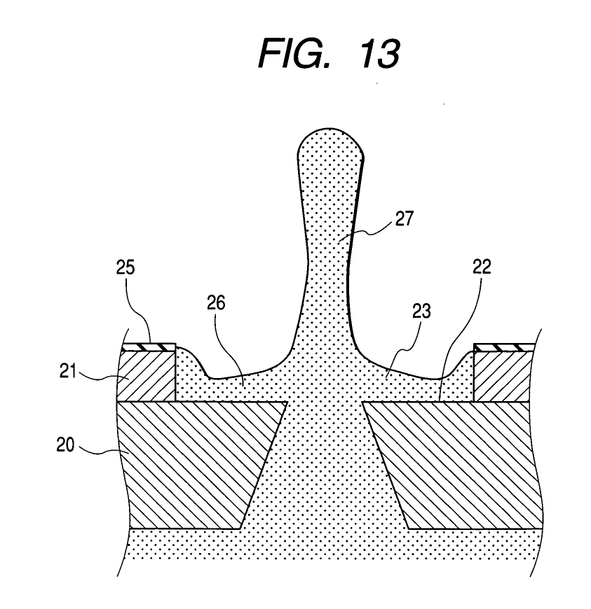

FIGS. 12A and 12B show another example of the invention. FIG. 12A is a plan view, and FIG. 12B is a cross-sectional view taken along line B-B shown in FIG. 12A.

The cover plate 21 is bonded to the nozzle plate 20 with the projecting section 23 being removed from the configuration of the first embodiment, whereby the step section 22 is formed and the nozzle exit 24 is provided within the step section 22. Further, the ink-repellent film 25 is provided on the surface of the cover plate 21.

Like the case of the embodiment shown in FIG. 10, the cover plate 21 may be subjected to ink-repellent treatment from the surface to the sidewall surface thereof. Ink can be dammed more reliably by means of such a configuration.

FIG. 13 is a conceptual rendering of a state achieved at the time of ejection of ink. The ink puddle 26 is formed within the step section 22, and the periphery of the nozzle exit 24 becomes evenly wet, whereby the ink droplet 27 stably travels in a straight line. The result of the test shows that the ejection rate and the amount of ink ejected have essentially no effect on the quantity of ink puddle 26. The ink puddle 26 remaining in the step section 22 is sufficiently close to the nozzle exit 24. Hence, the ink nozzle is withdrawn to the inside of the nozzle during periods between operations for ejecting ink droplets. Accordingly, the ink puddle 26 becomes saturated at a given quantity. Further, the ink-repellent film 25 is provided on the surface of the cover plate 21. As in the case of the first embodiment, there is yielded an effect of the nozzle substrate 2 being resistant to stains. Accordingly, ink can be stably ejected for a long period of time from the initiation of ejecting operation.

In the related-art example described in JP-UM-A-59-153128, the surface of the cover plate 21 is not subjected to ink-repellent treatment. Hence, ink flows to the flat section of the nozzle substrate 2 with the residual ink being taken as a starting point. Hence, there arises a necessity for frequently cleaning the nozzle substrate 2.

In the related-art example described in Japanese Patent No. 3,108,771, the wiper fails to come into sufficient contact with the angled portion of the step section 122 and that of the sidewall during the operation for cleaning the nozzle, as in the case of JP-A-5-509, and hence residual ink which would be caused during cleaning operation is likely to remain. When the inkjet head is operated continually over a long period of time, splashed ink adheres to the nozzle, thereby building up the residual ink 28 around the nozzle. When residual ink 28 rests on a portion of the nozzle 1 as a result of being built up, the periphery of the nozzle 1 becomes unevenly wet. As a result, the ink droplet 27 is withdrawn into the ink puddle, thereby causing a failure of the ink droplet to fly straight.

In contrast with the related-art example, the present invention yields an advantage of the ink puddle 26 absorbing the residual ink 28 remaining around the nozzle 1 and a merit of the ability to render the nozzle substrate 2 resistant to stains and stably eject ink for a long period of time.

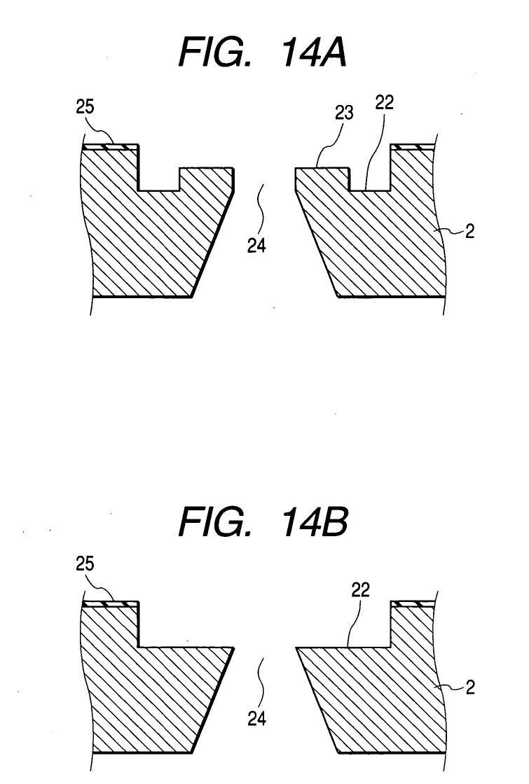

The foregoing embodiment has described an example in which the nozzle substrate 2 is constituted of two members. However, the nozzle substrate 2 can be constituted of one member. FIG. 14 shows a cross-sectional view obtained when the nozzle substrate 2 is constituted of one member. FIG. 14A shows an example in which the step section 22 has the projecting section 23, and FIG. 14B shows a case where the projecting section 23 is not provided. For instance, the foregoing shape can be readily embodied by one member by means of a method for pressing stainless steel, a method for electrocasting nickel, or a method for subjecting silicon or the like to dry etching.

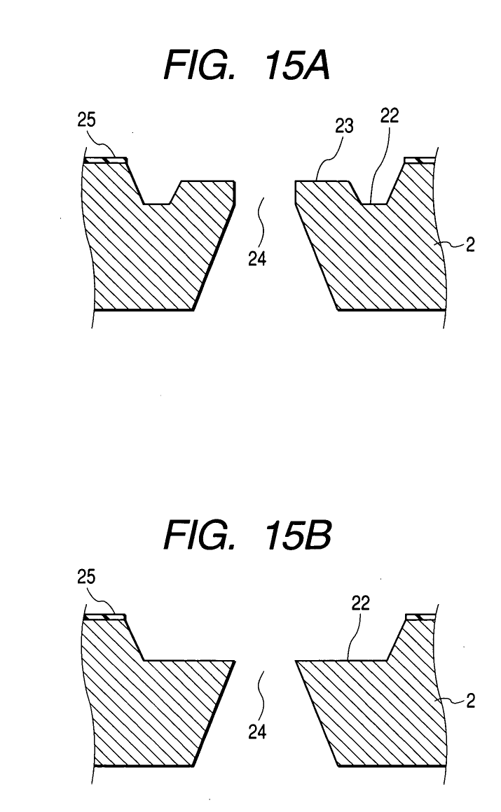

As shown in FIGS. 15A and 15B, the projecting section 23 and the sidewall surface of the step section 22 maybe tapered. FIG. 15A shows an example in which the projecting section 23 is provided on the step section 22; and FIG. 15B shows an example in which the step section 22 has no projecting section 23. As a result of the projecting section 23 or the sidewall surface of the step section 22 being tapered, there is yielded an effect of facilitating scraping away of an ink puddle or extraneous matter during a cleaning operation.

The above-described embodiment has described an ink-jet head utilizing displacement of a piezoelectric element. The present invention can also be applied to an inkjet head which ejects an ink droplet from a nozzle according to another method, such as a thermal method.

Since the present invention has the foregoing configuration, the following effect is yielded.

Since the periphery of the nozzle is uniformly wet by means of the projecting section, the rectilinear propagation characteristic of an ink droplet becomes stable. Further, since excessive ink flows to the step section, there is yielded an effect of shortening a ligament. Moreover, the step section is provided on the nozzle substrate, and the surface of the nozzle substrate is subjected to ink-repellent treatment. Hence, ink is prevented from extending outside the step section.

Even when ink has adhered to the surface of the nozzle substrate, the ink is absorbed by an ink puddle of the step section, thereby yielding an effect of rendering the nozzle substrate resistant to stains. An interval between cleaning operations can be made longer, and a certain amount of residual ink can be allowed. Hence, the cleaning device can be configured simply.

In addition, since the projecting section is made lower than the nozzle flat section, the nozzle exit becomes resistant to flaws which would be caused during cleaning of a head or when the recording medium comes into contact with the nozzle substrate.

What is claimed is:

1. An inkjet head, comprising:
a nozzle orifice;
a pressure chamber; and
a pressure generator that displaces an internal volume of the pressure chamber to eject an ink droplet from the nozzle orifice;
wherein the nozzle orifice includes a nozzle exit for ejecting ink, a first projecting section disposed around the nozzle exit, a step section disposed outside the first projecting section and a position lower than the same, and a second projecting section disposed outside the step section and at a position higher than the first projecting section; and
the second projecting section is subjected to ink-repellent treatment.

2. The inkjet head according to claim 1,
wherein the first section includes a front surface which is essentially concentric with an aperture of the nozzle exit; and
the front surface has a diameter two to four times the diameter of the nozzle exit.

3. The inkjet head according to claim 1,
wherein a height from the step section to the second projecting section is two-fifths to one time the diameter of the nozzle exit.

4. The inkjet head according to claim 1,
wherein the step section includes a bottom surface which is subjected to treatment for imparting affinity for ink.

5. The inkjet head according to claim 4,
wherein a contact angle made by the bottom surface of the step section with respect to pure water is 55° or less and a contact angle made by said second projecting section with respect to an ink-repellent treatment section is 100° or more.

6. An inkjet head, comprising:
a nozzle orifice;
a pressure chamber; and
a pressure generator for displacing an internal volume of the pressure chamber to eject an ink droplet from the nozzle orifice;
wherein the nozzle orifice includes a nozzle exit for ejecting ink and a projecting section being spaced a predetermined distance away from the nozzle exit; and
the projecting section is subjected to ink-repellent treatment.

7. The inkjet head according to claim 6,
wherein the projecting section is essentially concentric with a hole of the nozzle exit and has a diameter which is four to eight times the diameter of the nozzle exit.

8. The inkjet head according to claim 6,
wherein a height from the nozzle exit to the projecting section is two-fifths to one time the diameter of the nozzle exit.

9. A method for manufacturing an inkjet head for ejecting an ink droplet from a nozzle orifice section by displacing an internal volume of a pressure chamber by means of pressure generator comprising:
providing a nozzle plate with a plurality of nozzle exits for ejecting ink;
cementing a cover plate to a surface of the nozzle plate from which ink is to be ejected; and
subjecting the surface of the cover plate to ink-repellent film treatment to form the nozzle orifice.
